(19) United States
(12) Patent Application Publication
(10) Pub. No.: US 2023/0225506 A1
(43) Pub. Date: Jul. 20, 2023

(54) A Multifunctional Modular Furniture Unit and System

(71) Applicant: Kamran Daraiy, Tehran (IR)

(72) Inventors: Kamran Daraiy, Tehran (IR); Zahra Daraei, Munich (DE)

(73) Assignees: Zahra Daraei, Munich (DE); Tolou Salehi Eram Sadati, Tehran (IR)

(21) Appl. No.: 18/007,803

(22) PCT Filed: Jun. 2, 2021
(86) PCT No.: PCT/IB2021/054828

§ 371 Date: Dec. 2, 2022

(30) Foreign Application Priority Data
Jun. 2, 2020 (IR) 13995014000300216

(51) Int. Cl. A47B 85/00; A63H 33/04

(52) U.S. Cl. CPC A47B 85/00; A63H 33/04

(57) ABSTRACT

A multifunctional modular furniture unit and system is developed to build a various type of furniture and housing and office accessories that are used in interior design. The multifunctional modular furniture system comprises a plurality of modular units and a plurality of support units. The modular units comprise a top block unit, a link block unit, and a bottom block unit. The support units comprise a support strap and a connection cap. The various furniture can be built utilizing attaching the modular units to each other and using the support units to reinforce a furniture structure.

### CROSS REFERENCE TO RELATED APPLICATION

The present invention application claims priority from IR Patent Application, Application No 139950140003002162, filed on Jun. 2, 2021, entitled “PRODUCING FURNITURE, ALL KINDS OF COUCHES AND BEDS, BY USING BLOCK WITH SPECIAL TONGUE & GROOVE SYSTEM, MADE OF EXPANDED POLYSTYRENE (EPS)”, which is incorporated by reference herein in its entirety.

### TECHNICAL FIELD

The present disclosure is related to an interior design system, and in particular related to a modular furniture system, and a modular furniture unit for building various type of furniture and housing and office accessories.

### BACKGROUND ART

A wide variety of types and kinds of furniture and methods for assembling furniture exist in the furniture industry. common furniture, such as sofas, chairs, etc., is manufactured and assembled in a factory and shipped as complete units to be distributed and sold at retail and warehouse outlets. However, the complete furniture units, such as sofas, desks, etc. are bulky, difficult to move and maneuver, and costly to replace if they become aged or damaged. Also, in such designs, it is not possible to change and reconfigure the furniture structure.

The ready-to-assembly or the modular furniture attempts to solve many of the problems associated with the complete unit furniture as described above. The modular furniture typically is readily assembled and disassembled. The owner moves modular furniture by taking it apart and moving the parts to a new location. This advantage is particularly important in small spaces, such as small room or apartments which have close quarters.

Thus, based on the above-mentioned issues, an easy to use and multifunctional modular unit has been introduced to build a various type of furniture that can be used in interior design systems.

### SUMMARY OF INVENTION

This summary is intended to provide an overview of the subject matter of this disclosure, and is not intended to identify essential elements or key elements of the subject matter, nor is it intended to be used to determine the scope of the claimed implementations. The proper scope of this disclosure may be ascertained from the claims set forth below in view of the detailed description below and the drawings.

In one general aspect, the present disclosure is directed to an exemplary modular furniture unit. The exemplary modular furniture unit may comprise a top block that may configure to build a furniture top outer surface such that the top block may comprise a top face of the top block, at least four side faces of the top block, and a bottom face of the top block. In addition, the top face of the top block may include a flat surface and the side faces of the top block may extend orthogonally away from the top face of the top block to a bottom end of the top block and the bottom face of the top block may include at least one fastening groove. furthermore, the exemplary modular furniture unit may further comprise a bottom block that may configure to build a furniture bottom surface on a ground such that the bottom block may comprise a top face of the bottom block, at least four side faces of the bottom block, and a bottom face of the bottom block. Moreover, the top face of the bottom block may include at least one fastening protrusion and the side faces of the bottom block may extend orthogonally away from the top face of the bottom block to a bottom end of the bottom block. Additionally, the exemplary modular furniture unit may further comprise a link block that may configure to build a furniture main body such that the link block may comprise a top face of the link block, at least four side faces of the link block, and a bottom face of the link block. Furthermore, the top face of the link block may include at least one fastening protrusion and the side faces of the link block may extend orthogonally away from the top face of the link block to a bottom end of the link block and the bottom face of the link block may comprise at least one fastening groove. Moreover, the bottom face of the top block may configure to connect the top block to the top face of the link block or the top face of the bottom block. In addition, the top face of the link block may configure to connect the link block to the bottom face of the top block or a bottom face of another link block and the bottom face of the link block may configure to connect the link block to the top face of the bottom block or a top face of another link block. Furthermore, the top face of the bottom block may configure to connect the bottom block to the bottom face of the link block or the bottom face of the top block.

The above general aspect may have one or more of the following features. In an exemplary implementation, the modular furniture unit may be made of a polystyrene material. In an exemplary implementation, the bottom face of the link block and the bottom face of the top block may further comprise at least one string groove such that the string groove may configure to facilitate a furniture structure reconfigure and a passage of a transverse string. In an exemplary implementation, the transverse string may configure to connect a furniture cover to a furniture body. In an exemplary implementation, the string groove may be embedded transversely and longitudinally within the bottom face of the link block and the bottom face of the top block. In an exemplary implementation, the bottom face of the bottom block may comprise at least one connection cap aperture. In an exemplary implementation, the top face of the link block may comprise at least one connection cap aperture such that the connection cap aperture may embedded within a fastening protrusion tip. In an exemplary implementation, the fastening protrusion and the fastening groove may comprise a Lego-type fastening protrusion and a Lego-type fastening groove. In an exemplary implementation, the fastening protrusion and fastening groove may comprise a polygonal cross section geometry and an inner hollow space. In an exemplary implementation, the polygonal cross section geometry may comprise an octagonal cross-section. In an exemplary implementation, the fastening groove may be designed with a recess in the bottom face of the top block and the bottom face of the link block. In an exemplary implementation, the recess may have an octagonal cylindrical shape. In an exemplary implementation, the octagonal cylindrical shape may comprise a first section and a second section with a different inner diameter such that an inner diameter of the first section may be larger than an inner diameter of the second section such that the fastening protrusion may enter the fastening groove from the second section. In an exemplary implementation, the inner hollow space may configure to pass a support strap. In an exemplary implementation, a connection cap may configure to fasten the support strap and the connection cap may be mounted on the connection cap aperture.

In another general aspect, the present disclosure is directed to exemplary multifunctional modular furniture system to produce various type of a furniture. The exemplary system may comprise a plurality of modular units that may configure to build a furniture structure such that the modular units may include a top block unit, a link block unit, and a bottom block unit such that the top block unit may configure to build a furniture top outer surface, a link block unit may configure to build a furniture main body and the bottom block unit may configure to build a furniture bottom surface on a ground. Furthermore, the exemplary system may further comprise a plurality of support units that may configure to reinforce the furniture structure against a pressure on the furniture structure such that the support units may include a support strap and a connection cap. In addition, the support strap may configure to protect the furniture against a horizontal force on the furniture structure and the connection cap may configure to fasten the support strap.

The above general aspect may have one or more of the following features. In an exemplary implementation, the modular units may be made of a polystyrene material. In an exemplary implementation, the modular units may be made of an expanded polystyrene. In an exemplary implementation, the modular units may have a polyhedron geometry. In an exemplary implementation, the top block unit may comprise at least four flat side walls, a flat top surface, and a top block connection side such that the top block connection side may be embedded in a bottom surface of the top block unit and the top block connection side may include at least one Lego-type fastening groove. In an exemplary implementation, the link block unit may comprise at least four flat side walls, a first link block connection side, and a second link block connection side such that the first link block connection side may be embedded in a top surface of the link block unit and the second link block connection side may be embedded in a bottom surface of the link block unit such that the first link block connection side may include at least one Lego-type fastening protrusion and the second link block connection side may include at least one Lego-type fastening groove. In an exemplary implementation, the bottom block unit may comprise at least four flat side walls, a bottom block connection side, and a bottom surface such that the bottom block connection side may include at least one Lego-type fastening protrusion and the bottom surface may include at least one connection cap cylindrical aperture and at least one flat cap cylindrical aperture. In an exemplary implementation, the Lego-type fastening protrusion and the Lego-type fastening groove may comprise a polygonal cross section geometry and an inner hollow space that may configure to pass the support strap. In an exemplary implementation, the Lego-type fastening protrusion may extend from a modular unit's surface such that the Lego-type fastening protrusion may have an octagonal cross-section. In an exemplary implementation, the Lego-type fastening groove may comprise the octagonal cross-section and the Lego-type fastening groove may be designed with a recess within the modular unit's surface. In an exemplary implementation, the recess in the modular unit's surface may comprise an octagonal cylindrical shape. In an exemplary implementation, the octagonal cylindrical shape may comprise a first section and a second section with a different inner diameter such that an inner diameter of the first section may be larger than an inner diameter of the second section such that the fastening protrusion may enter the fastening groove from the second section.

In another general aspect, the present disclosure is directed to exemplary multifunctional modular furniture system to produce various type of a furniture. The exemplary system may comprise a plurality of modular units that may configure to build a furniture structure such that the modular units may include a top block unit that may configure to build a furniture top outer surface, a link block unit that may configure to build a furniture main body, and a bottom block unit that may configure to build a furniture bottom surface on a ground such that top block unit may include at least one fastening groove and the link block unit may include at least one fastening groove and at least one fastening protrusion and the bottom block unit may include at least one fastening protrusion. In addition, the fastening groove may comprise at least two section with an octagonal cylindrical shape with a different inner diameter such that an inner diameter of a first section may be larger than an inner diameter of a second section. Furthermore, the first section may be mounted on a top of the second section such that the fastening protrusion may enter the fastening groove from a bottom of the second section. In addition, the exemplary system may further comprise a plurality of support units that may configure to reinforce the furniture structure against a pressure on the furniture structure such that the support units may include a support strap and a connection cap such that the support strap may configure to protect the furniture against a horizontal force on the furniture structure and the connection cap may configure to fasten the support strap.

### BRIEF DESCRIPTION OF DRAWINGS

The drawing figures depict one or more implementations in accordance with the present teachings, by way of example only, not by way of limitation. In the figures, like reference numerals refer to the same or similar elements.

FIG. 1 illustrates an isometric view of a furniture design utilizing a modular furniture unit and system, consistent with one or more exemplary embodiments of the present disclosure.

FIG. 2A illustrates an isometric view of a top block unit, consistent with one or more exemplary embodiments of the present disclosure.

FIG. 2B illustrates a cross-sectional view of a top block unit, consistent with one or more exemplary embodiments of the present disclosure.

FIG. 3 illustrates an isometric view of a plurality of top block unit configurations, consistent with one or more exemplary embodiments of the present disclosure.

FIG. 4A illustrates an isometric view of a link block unit, consistent with one or more exemplary embodiments of the present disclosure.

FIG. 4B illustrates a cross-sectional view of a link block unit, consistent with one or more exemplary embodiments of the present disclosure.

FIG. 5 illustrates an isometric view of a plurality of link block unit configurations, consistent with one or more exemplary embodiments of the present disclosure.

FIG. 6A illustrates an isometric view a of a bottom block unit, consistent with one or more exemplary embodiments of the present disclosure.

FIG. 6B illustrates a cross-sectional view of a bottom block unit, consistent with one or more exemplary embodiments of the present disclosure.

FIG. 7 illustrates an isometric view of a plurality of bottom block unit configurations, consistent with one or more exemplary embodiments of the present disclosure.

FIG. 8A illustrates a connection diagram of a link block unit, consistent with one or more exemplary embodiments of the present disclosure.

FIG. 8B illustrates a connection diagram of a top block unit, consistent with one or more exemplary embodiments of the present disclosure.

FIG. 8C illustrates a connection diagram of a bottom block unit, consistent with one or more exemplary embodiments of the present disclosure.

FIG. 9A illustrates a cross-sectional view of a fastening protrusion and a fastening groove design, consistent with one or more exemplary embodiments of the present disclosure.

FIG. 9B illustrates a top view of a fastening protrusion and a fastening groove design, consistent with one or more exemplary embodiments of the present disclosure.

FIG. 10 illustrates an isometric view of a connection cap, consistent with one or more exemplary embodiments of the present disclosure.

FIG. 11 illustrates an isometric view of a flat cap, consistent with one or more exemplary embodiments of the present disclosure.

FIG. 12 illustrates a schematic view for a sofa assembly utilizing a multifunctional modular furniture system units and, consistent with one or more exemplary embodiments of the present disclosure.

### DESCRIPTION OF EMBODIMENTS

In the following detailed description, numerous specific details are set forth by way of examples in order to provide a thorough understanding of the relevant teachings. However, it should be apparent that the present teachings_may be practiced without such details. In other instances, well-known methods, components, and/or elements have been described at a relatively high-level, without detail, in order to avoid unnecessarily obscuring aspects of the present teachings. The following detailed description is, therefore, not to be taken in a limiting sense, and the scope of the present disclosure is defined only by the appended claims.

The following detailed description is presented to enable a person skilled in the art to make and use the methods and apparatuses disclosed in exemplary embodiments of the present disclosure. For purposes of explanation, specific nomenclature is set forth provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

“Polystyrene material”, as used herein, refers to an expanded polystyrene with different molecular weight or any other materials having a density and mechanical properties as same as the expanded polystyrene.

In an exemplary embodiment, an exemplary multifunctional modular furniture unit and system may be developed to build various type of a furniture and a housing and office accessory.

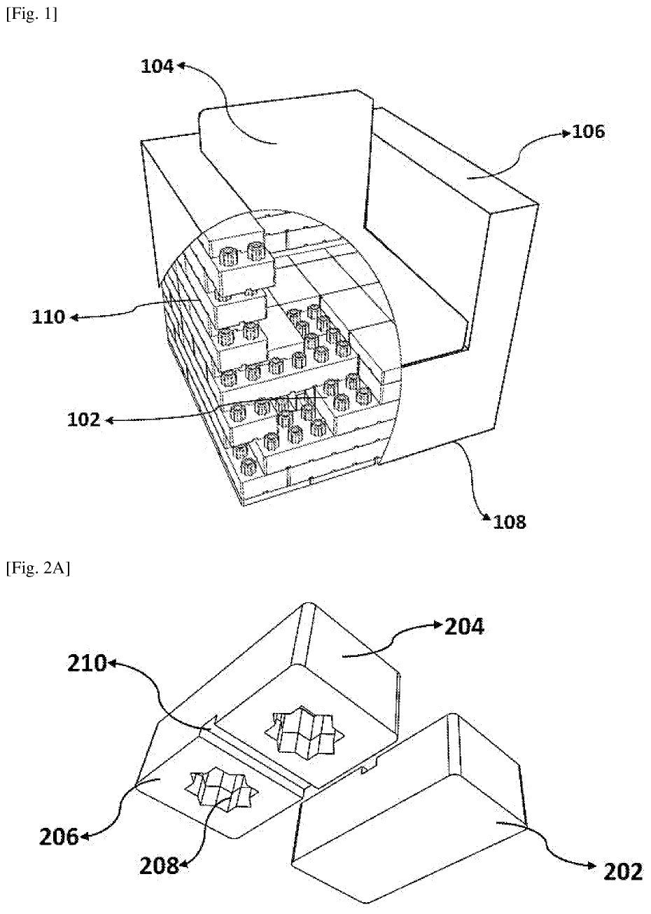

FIG. 1 illustrates an exemplary isometric view of a furniture design (100) utilizing the modular furniture unit and system, consistent with one or more exemplary embodiments of the present disclosure. In an exemplary embodiment, as illustrated in FIG. 1, the furniture design (100) may comprise a plurality of modular furniture units (102), a furniture cover (104), a furniture top outer surface (106), a furniture bottom surface (108), and a furniture main body (110).

In an exemplary embodiment, the modular furniture units (102) may configure to build a furniture structure. In an exemplary embodiment, the modular furniture units (102) may be made of a polystyrene material. In an exemplary embodiment, the polystyrene material may comprise expanded polystyrene. In an exemplary embodiment, the modular furniture units (102) may have a polyhedron geometry. In an exemplary embodiment, the polyhedron geometry may comprise a cubic geometry or other geometries that are well known for those skilled in the art. In an exemplary embodiment, the modular furniture units (102) may comprise a top block unit, a link block unit, and a bottom block unit. In an exemplary embodiment, the top block unit may configure to build a furniture top outer surface (106), the link block unit may configure to build a furniture main body (110), and the bottom block unit may configure to build a furniture bottom surface (108).

In an exemplary embodiment, the modular furniture units (102) may be connected to one another to form a multifunctional modular furniture system. In an exemplary embodiment, the multifunctional modular furniture system may comprise a plurality of support units. In an exemplary embodiment, the support units may configure to reinforce the furniture structure against a pressure on the furniture structure. In an exemplary embodiment, the support units may comprise a support strap. In an exemplary embodiment, the support strap may configure to integrate the furniture structure and protect a furniture against a horizontal force that may be applied on the furniture structure. In an exemplary embodiment, the support strap may comprise a fishing line, a rope, or other type of straps that are well known for those skilled in the art.

In an exemplary embodiment, the furniture cover (104) may comprise a fabric cover, a leather cover, a slipcover, or other type of covers that are well known for those skilled in the art. In an exemplary embodiment, the furniture design (100) may comprise at least one cushion, at least one pillow, or other soft pads that are well known for those skilled in the art. In an exemplary embodiment, the soft pads may be placed on a seating area of the furniture that configure to provide a comfortably sitting.

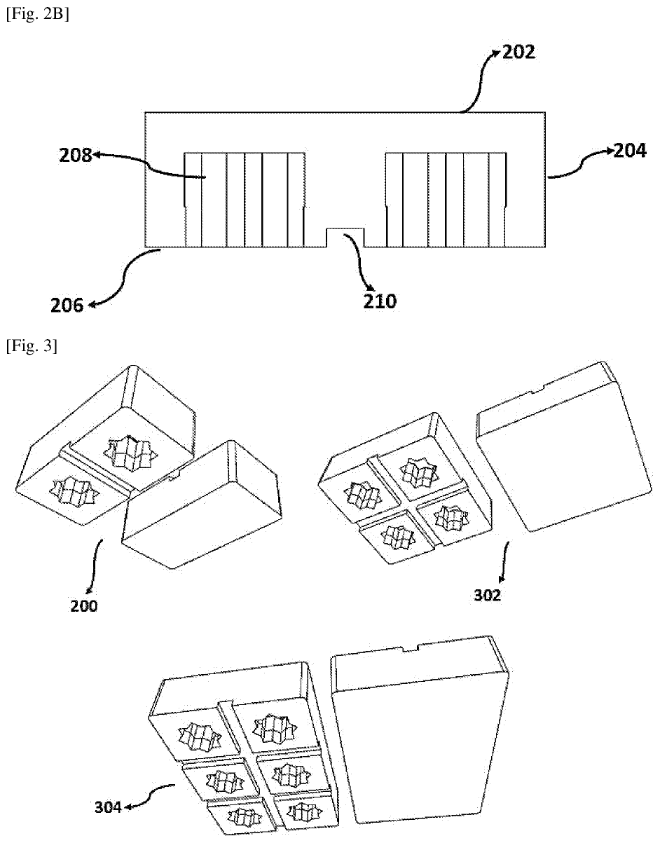

FIG. 2A illustrates an exemplary isometric view of a top block unit (200), consistent with one or more exemplary embodiments of the present disclosure. In an exemplary embodiment, as illustrated in FIG. 2A, the top block unit (200) may comprise a top face of the top block unit (202), at least four side faces of top block unit (204), and a bottom face of the top block unit (206).

In an exemplary embodiment, the top face of the top block unit (202) may comprise a flat surface. In an exemplary embodiment, the side faces of the top block unit (204) may extend orthogonally away from the top face of the top block unit (204) to a bottom end of the top block unit. In an exemplary embodiment, the side faces of the top block unit (204) may comprise the flat surface. In an exemplary embodiment, the bottom face of the top block unit (206) may comprise at least one top block fastening groove (208) and at least one top block string groove (210). In an exemplary embodiment, the top block string groove (210) may configure to facilitate a furniture structure reconfigure and a passage of a transverse string such that the transverse string may pass through the link block rows in a perpendicular direction. In an exemplary embodiment, the transverse string may configure to connect the furniture cover (104) to a furniture body. In an exemplary embodiment, the string groove may be embedded transversely and longitudinally within the bottom face of the top block (206). In an exemplary embodiment, the exemplary top block unit (200) may come in a different size, shape, and configuration for increased customization to fit any size space and a desired configuration.

FIG. 3 illustrates a plurality of top block unit configurations, consistent with one or more exemplary embodiments of the present disclosure. In an exemplary embodiment, the plurality of top block unit configurations may configure to build different models of the furniture through connecting to each other. In an exemplary embodiment, as illustrated in FIG. 3, the top block unit configurations may comprise a 2*1 array block (200), a 2*2 array block (302), a 2*3 array block (304), or other configurations that are well known for those skilled in the art.

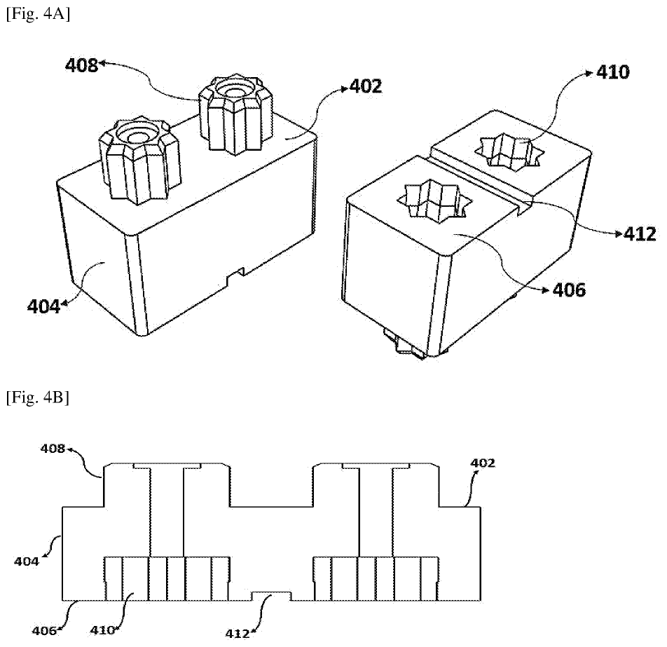

FIG. 4A illustrates an exemplary isometric view of a link block unit (400), consistent with one or more exemplary embodiments of the present disclosure. In an exemplary embodiment, as illustrated in FIG. 4A, the link block unit (400) may comprise a top face of the link block unit (402), at least four side faces of the link block unit (404), and a bottom face of the link block unit (406).

In an exemplary embodiment, the top face of the link block unit (402) may comprise at least one link block fastening protrusion (408). In an exemplary embodiment, the side faces of the link block unit (404) may extend orthogonally away from the top face of the link block unit (404) to a bottom end of the link block unit (400). In an exemplary embodiment, the side faces of the link block unit (404) may comprise the flat surface. In an exemplary embodiment, the bottom face of the link block unit (406) may comprise at least one link block fastening groove (410) and at least one link block string groove (412) such that the link block string groove (412) may configure to facilitate the furniture structure reconfigure and the passage of the transverse string. In an exemplary embodiment, the transverse string may configure to connect the furniture cover (104) to the furniture body. In an exemplary embodiment, the link block string groove (412) may be embedded transversely and longitudinally within the bottom face of the exemplary link block unit (406). In an exemplary embodiment, the exemplary link block unit (400) may come in different size, shape, and configuration for increased customization to fit any size space and a desired configuration.

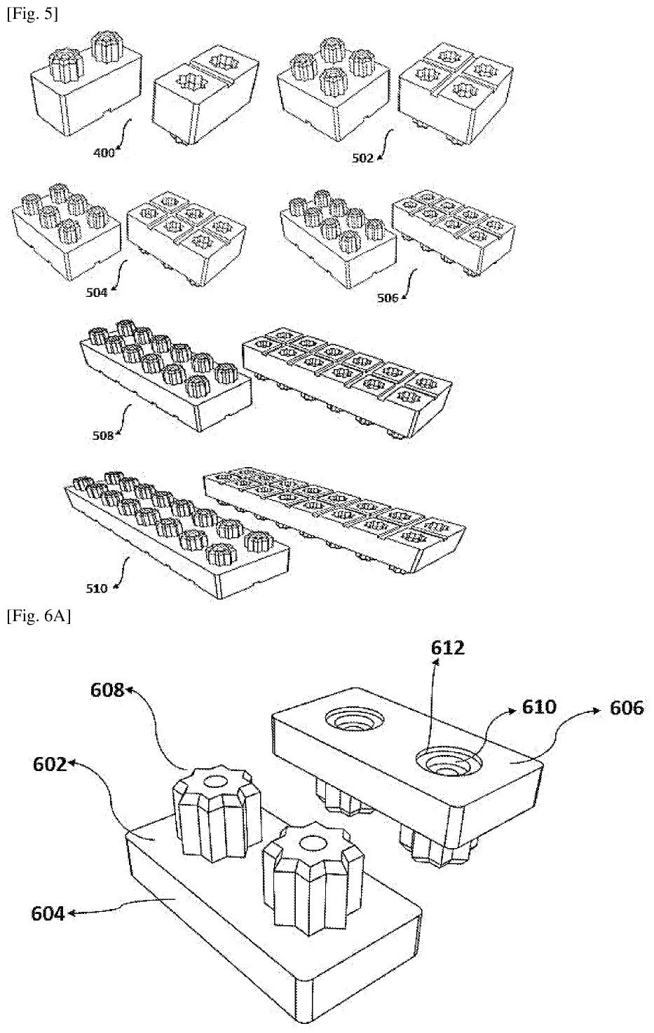

FIG. 5 illustrates a plurality of link block unit configurations, consistent with one or more exemplary embodiments of the present disclosure. In an exemplary embodiment, the plurality of link block unit configurations may configure to build different models of the furniture through connecting to each other. In an exemplary embodiment, as illustrated in FIG. 5, the link block unit configurations may comprise a 2*1 array block (400), a 2*2 array block (502), a 2*3 array block (504), a 2*4 array block (506), a 2*6 array block (508), a 2*8 array block (510), or other configurations that are well known for those skilled in the art.

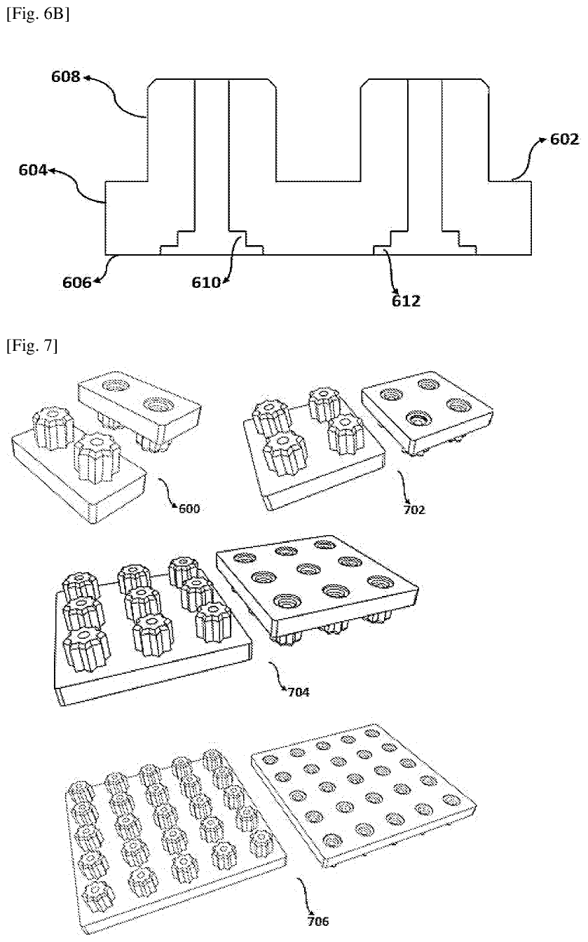

FIG. 6A illustrates an exemplary isometric view of a bottom block unit (600), consistent with one or more exemplary embodiments of the present disclosure. In an exemplary embodiment, as illustrated in FIG. 6A, the bottom block unit (600) may comprise a top face of the bottom block unit (602), at least four side faces of the bottom block unit (604), and a bottom face of the bottom block unit (608).

In an exemplary embodiment, the top face of the bottom block unit (602) may comprise at least one bottom block fastening protrusion (608). In an exemplary embodiment, the side faces of the bottom block unit (604) may extend orthogonally away from the top face of the bottom block unit (604) to a bottom end of the bottom block unit (602). In an exemplary embodiment, the side faces of the link block unit (604) may comprise the flat surface. In an exemplary embodiment, the bottom face of the bottom block unit (606) may comprise at least one bottom block connection cap aperture (610) and at least one flat cap aperture (612). In an exemplary embodiment, the bottom block connection cap aperture (610) and the flat cap aperture (612) may comprise a cylindrical shape aperture or other shapes that are well known for those skilled in the art. In an exemplary embodiment, the bottom block connection cap aperture (610) and the flat cap aperture (612) may be designed with a recess in the bottom face of the bottom block unit (606). In an exemplary embodiment, a diameter of the flat cap aperture (612) may be larger than a diameter of the bottom block connection cap aperture (610). In an exemplary embodiment, the exemplary bottom block unit (600) may come in different size, shape and configuration for increased customization to fit any size space and a desired configuration.

FIG. 7 illustrates a plurality of bottom block unit configurations, consistent with one or more exemplary embodiments of the present disclosure. In an exemplary embodiment, the plurality of bottom block unit configurations may configure to build different models of furniture through connecting to each other. In an exemplary embodiment, as illustrated in FIG. 7, the bottom block unit configurations may comprise a 2*1 array block (600), a 2*2 array block (702), a 3*3 array block (704), a 5*5 array block (706), or other configurations that are well known for those skilled in the art.

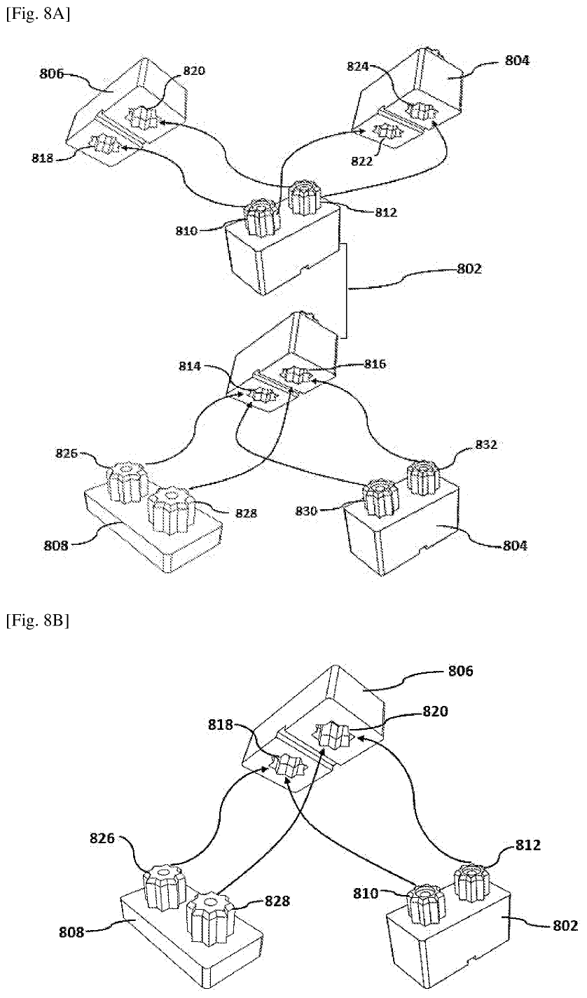

FIG. 8A illustrates an exemplary connection diagram of a first link block unit (802), consistent with one or more exemplary embodiments of the present disclosure. In an exemplary embodiment, as illustrated in FIG. 8A, the first link block unit (802) may be attached to a top block unit (806) such that a top side of a furniture may be built, or the first link block unit (802) may be attached to a bottom block unit (808) such that a bottom side of the furniture may be constructed, or may be attached to a second link block unit (804) such that the furniture main body (110) may be constructed.

In an exemplary embodiment, a first fastening protrusion of the first link block unit (810) may configure to insert into a first fastening groove of the top block unit (818) or a first fastening groove of the second link block unit (822). In an exemplary embodiment, a second fastening protrusion of the first link block unit (812) may configure to insert into a second fastening groove of the top block unit (820) or a second fastening groove of the second link block unit (824).

In an exemplary embodiment, a first fastening groove of the first link block unit (814) may affix to a first fastening protrusion of the bottom block unit (826) or a first fastening protrusion of the second link block unit (830). In an exemplary embodiment, a second fastening groove of the first link block unit (816) may affix to a second fastening protrusion of bottom block unit (828) or a second fastening protrusion of the second link block unit (832).

FIG. 8B illustrates an exemplary connection diagram of the top block unit (806), consistent with one or more exemplary embodiments of the present disclosure. In an exemplary embodiment, as illustrated in FIG. 8B, the top block unit (806) may be attached to the bottom block unit (808) or the first link block unit (802) such that the top side of a furniture may be built.

In an exemplary embodiment, a first fastening groove of the top block unit (818) may affix to the first fastening protrusion of bottom block unit (826) or the first fastening protrusion of the link block unit (810). In an exemplary embodiment, the second fastening groove of the top block unit (820) may affix to the second fastening protrusion of bottom block unit (828) or the second fastening protrusion of the link block unit (812).

FIG. 8C illustrates an exemplary connection diagram of the bottom block unit (808), consistent with one or more exemplary embodiments of the present disclosure. In an exemplary embodiment, as illustrated in FIG. 8C, the bottom block unit (808) may be attached to the first link block unit (802) or the top block unit (806) such that the bottom side of the furniture may be constructed.

In an exemplary embodiment, the first fastening protrusion of the bottom block (826) may configure to insert into the first fastening groove of top block unit (818) or the first fastening groove of the first link block unit (814). In an exemplary embodiment, the second fastening protrusion of the bottom block unit (828) may configure to insert into the second fastening groove of the top block unit (820) or the second fastening groove of the first link block unit (816).

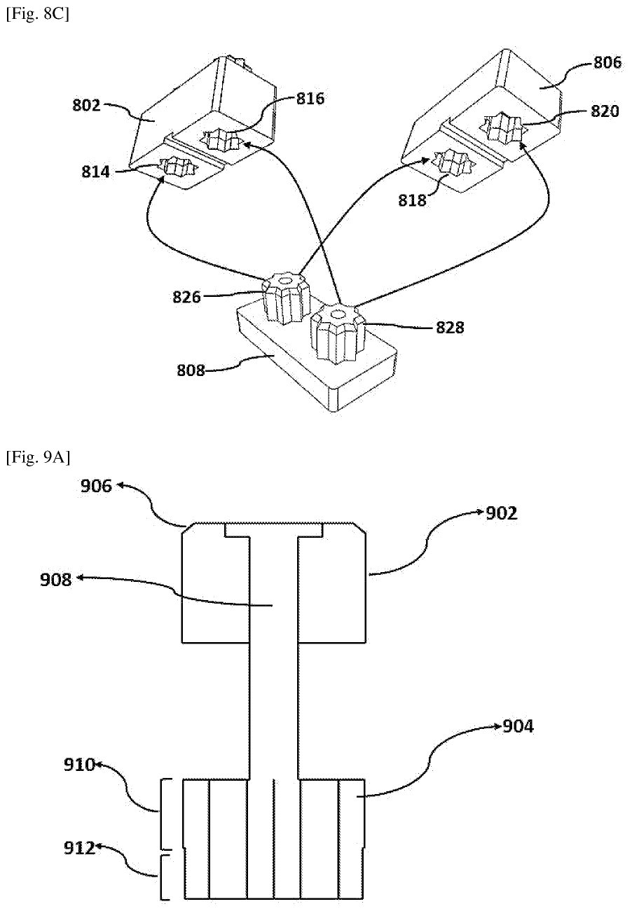

FIG. 9A illustrates an exemplary cross-sectional view of a fastening protrusion and a fastening groove design, consistent with one or more exemplary embodiments of the present disclosure. In addition, FIG. 9B illustrates an exemplary top view of a fastening protrusion and a fastening groove design, consistent with one or more exemplary embodiments of the present disclosure.

In an exemplary embodiment, the fastening protrusion (902) may be embedded within a top surface of the bottom block unit (600) and a top surface of the link block unit (400). In an exemplary embodiment, the fastening protrusion (902) may comprise a Lego-type fastening protrusion. In an exemplary embodiment, the fastening protrusion (902) may comprise a polygonal cross section geometry and an inner hollow space (908). In an exemplary embodiment, the polygonal cross section geometry may comprise an octagonal shape cross-section (914) or other shapes that are well known for those skilled in the art. In an exemplary embodiment, the octagonal cross-section (914) may comprise at least two concentric squares with a rotation angle relative to each other's diameter line. In an exemplary embodiment, a fastening protrusion tip may comprise a sloping edge (906) such that the sloping edge (906) may configure to facilitate an entry of the fastening protrusion (902) into the fastening groove (904).

In an exemplary embodiment, the fastening groove (904) may be embedded within the bottom surface of the top block unit and the bottom surface of the link block unit. In an exemplary embodiment, the fastening groove (904) may comprise a Lego-type fastening groove. In an exemplary embodiment, the fastening groove (904) may comprise the polygonal cross section geometry and the inner hollow space (908). In an exemplary embodiment, the polygonal cross section geometry may comprise an octagonal cross-section (918) or other geometries that are well known for those skilled in the art. In an exemplary embodiment, the octagonal cross-section (918) may comprise at least two concentric squares with a rotation angle relative to each other's diameter line. In an exemplary embodiment, the fastening groove (904) may comprise a first section (910) and a second section (912) with a different inner diameter. In an exemplary embodiment, an inner diameter of the first section (912) is larger than an inner diameter of the second section (910). In an exemplary embodiment, the fastening protrusion (902) may be able to deform inside the fastening groove (904). In an exemplary embodiment, an upper part of fastening protrusion (902) may be widened due to a pressure on the furniture structure and gradually the fastening protrusion (902) may be moved from the second section (910) to the first section (912) and so that the fastening protrusion (902) may takes on a T shape inside the fastening groove (904) and the fastening protrusion (902) is tightened inside the fastening groove (904). In an exemplary embodiment, the fastening protrusion (902) and fastening groove (904) may also be responsible for transferring some of a furniture mechanical load to the modular furniture units (102). In an exemplary embodiment, the fastening protrusion (902) and the fastening groove (904) may be designed to increase a connection strength and prevent a furniture structure wear.

In an exemplary embodiment, the link block fastening protrusion (408) may comprise a link block connection cap aperture (916). In an exemplary embodiment, the link block connection cap aperture (916) may comprise a cylindrical shape aperture or other shapes that are well known for those skilled in the art. In an exemplary embodiment, the inner hollow space (908) may comprise a hollow cylinder. In an exemplary embodiment, the inner hollow space (908) may configure to pass the support strap.

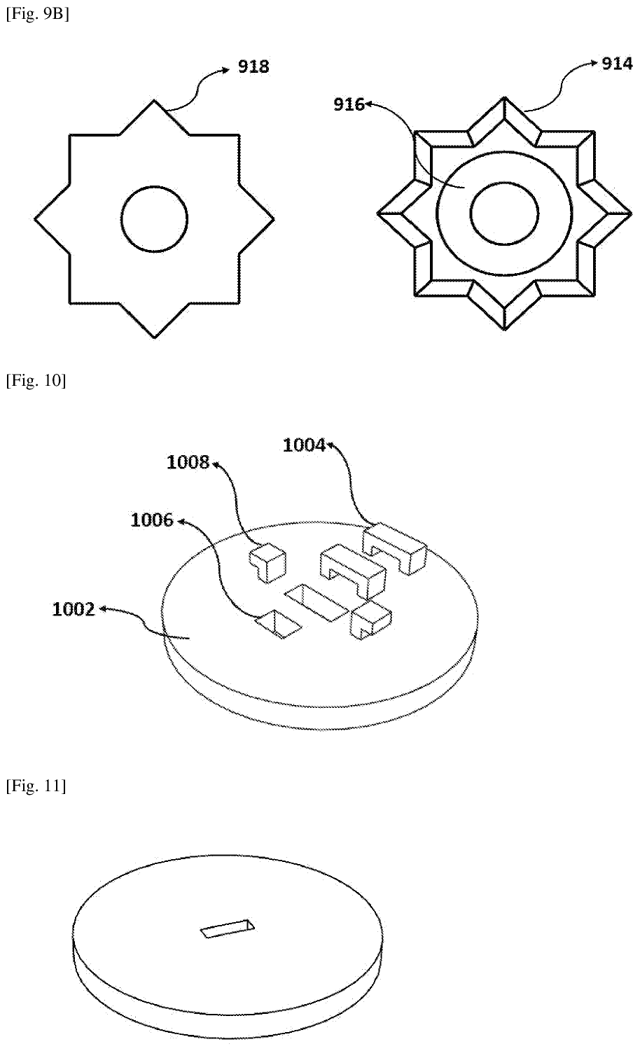

FIG. 10 illustrates an exemplary isometric view of a connection cap (1000), consistent with one or more exemplary embodiments of the present disclosure. In an exemplary embodiment, as illustrated in FIG. 10, the exemplary connection cap (1000) may comprise two pinch dog clamps (1004), two L-type clamps (1008), and at least two holes (1006).

In an exemplary embodiment, the clamp (1004) may configure to attach the support strap to the connection cap (1000) utilizing tying the support strap to the pinch dog clamps (1004) and the L-type clamps (1008). In an exemplary embodiment, the holes (1006) may configure to pass the support strap. In an exemplary embodiment, the connecting cap (1000) may have a variety of structures depending on a type of connection.

FIG. 11 illustrates an exemplary isometric view of a flat cap (1100), consistent with one or more exemplary embodiments of the present disclosure.

In an exemplary embodiment, the flat cap (1100) may be inserted into the flat cap aperture (612) to conceal a furniture opening for aesthetics.

### Example

### Fabrication of a Sofa Utilizing a Multifunctional Modular Furniture System

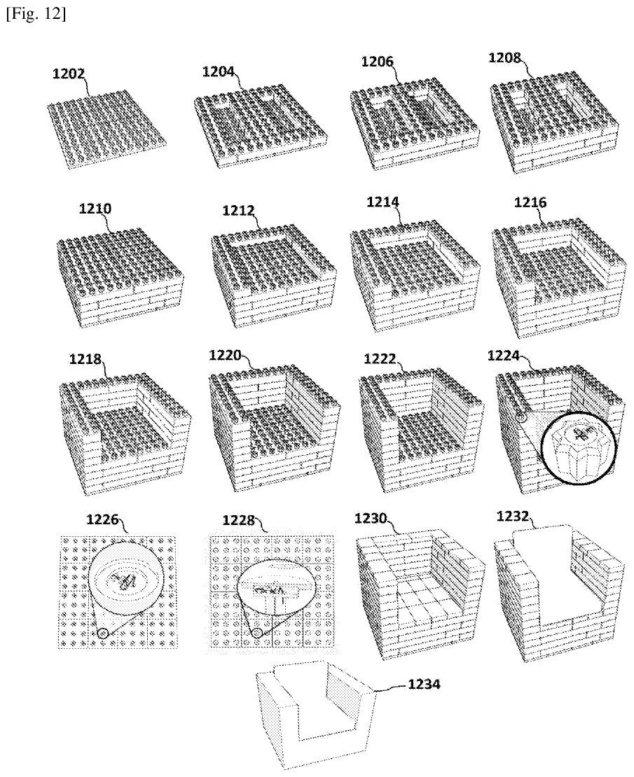

In this example, as illustrated in FIG. 12, an exemplary sofa was fabricated consistent with the teachings of exemplary embodiments of the present disclosure. In a first step, a bottom face of the exemplary sofa was built utilizing sixteen exemplary 3*3 array bottom blocks such that the bottom face of the exemplary sofa was placed on a ground and a first layer of the exemplary sofa was built. In this case, the sixteen exemplary 3*3 array bottom blocks were arranged in 4-rows, 4-columns arrangement (1202). In a second step, a second layer of the exemplary sofa was built utilizing four exemplary 2*8 array link blocks and six exemplary 2*4 array link blocks (1204). Following that, a 3^{th} layer of the exemplary sofa was fabricated utilizing five exemplary 2*8 array link blocks and two exemplary 2*4 array link blocks (1206). Afterward, four exemplary 2*8 array link blocks and six exemplary 2*4 array link blocks similar to the 2^{th} sofa layer (1208) was applied to construct a fourth layer of the exemplary sofa. In next step, a fifth layer of the exemplary sofa layer was built utilizing twelve exemplary 2*6 array link blocks (1210). Then, for fabrication of a sixth layer of the exemplary sofa, three exemplary 2*8 array link blocks and two exemplary 2*4 array link blocks (1212) were attached to a top of the exemplary blocks of the fifth layer to build an arm and a back of the exemplary sofa. Afterward, by utilizing four exemplary 2*6 array link blocks and two exemplary 2*4 array link blocks (1214) a 7^{th} sofa layer was constructed. Following that, an 8^{th} layer of the exemplary sofa was built utilizing three exemplary 2*8 array link blocks and two exemplary 2*4 array link blocks (1216). Afterward, a 9^{th} layer of the exemplary sofa was constructed as same as the 7^{th} layer (1218), a 10^{th} sofa layer (1220) was built similar to the sixth layer, and a 11^{th} layer of the exemplary sofa (1222) were built similar to the 7^{th} layer. Following that, twenty-four exemplary connection caps were mounted within the link block units (1224) and twenty-four exemplary connection caps were mounted within the bottom block units (1226). Following that, twenty-four support straps were attached to the connection caps of the link block units that placed on the 11^{th} layer of the exemplary sofa through tying the support straps to the pinch dog clamps (1004) and L-type clamps (1008) that mounted on the connection caps (1224). Afterward, the support straps passed through the link block units and directed to the bottom block units that placed on the first layer of the exemplary sofa. Following that, the support straps were attached to the connection caps of the bottom block units that placed on the 1^{th} sofa layer through tying the support straps to the pinch dog clamps (1004) and L-type clamps (1008) that mounted on the connection caps (1226). Afterward, one hundred and forty-four exemplary flat caps were placed on the bottom block units to conceal the sofa openings (1228). Afterward, a 12^{th} layer of the exemplary sofa was constructed utilizing six exemplary 2*3 array top block units and seven exemplary 2*2 array top block units such that a flat top outer face of the exemplary sofa was built (1230). finally, a cushion was placed on a sofa seat (1232) and a fabric cover was attached to a sofa body (1234).

Furthermore, it is to be understood that the invention is solely defined by the appended claims. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood that the terms and expressions used herein have the ordinary meaning as is accorded to such terms and expressions with respect to their corresponding respective areas of inquiry and study except where specific meanings have otherwise been set forth herein. Relational terms such as first, second, and third and the like may be used solely to distinguish one entity or action from another without necessarily requiring or implying any actual such relationship or order between such entities or actions. The terms “comprises,” “comprising,” “include,” or any other variation thereof, are intended to cover a non-exclusive inclusion, such that a process, method, article, apparatus, or device that comprises a list of elements does not include only those elements but may include other elements not expressly listed or inherent to such process, method, article, apparatus, or device. An element proceeded by “a” or “an” does not, without further constraints, preclude the existence of additional identical elements in the process, method, article, or device that comprises the element. Moreover, “may” and other permissive terms are used herein for describing optional features of various embodiments. These terms likewise describe selectable or configurable features generally, unless the context dictates. Otherwise.

1. A modular furniture unit comprising:
(i) a top block configured to build a furniture top outer surface, the top block comprising:
a top face of the top block comprising a flat surface;
at least four side faces of the top block extending orthogonally away from the top face of the top block to a bottom end of the top block; and
a bottom face of the top block comprising at least one fastening groove;
(ii) a bottom block configured to build a furniture bottom surface on a ground, the bottom block comprising:
a top face of the bottom block comprising at least one fastening protrusion;
at least four side faces of the bottom block extending orthogonally away from the top face of the bottom block to a bottom end of the bottom block; and
a bottom face of the bottom block;
(iii) A link block configured to build a furniture main body, the link block comprising:
a top face of the link block comprising at least one fastening protrusion;
at least four side faces of the link block extending orthogonally away from the top face of the link block to a bottom end of the link block; and
a bottom face of the link block comprising at least one fastening groove, wherein:
the bottom face of the top block configured to connect the top block to the top face of the link block or the top face of the bottom block;
the top face of the link block configured to connect the link block to the bottom face of the top block or a bottom face of another link block;
the bottom face of the link block configured to connect the link block to the top face of the bottom block or a top face of another link block; and
the top face of the bottom block configured to connect the bottom block to the bottom face of the link block or the bottom face of the top block.

2. The modular furniture unit according to claim 1, wherein the modular furniture unit is made of a polystyrene material.

3. The modular furniture unit according to claim 1, wherein the bottom face of the link block and the bottom face of the top block further comprise at least one string groove, wherein the string groove configured to facilitate a furniture structure reconfigure and a passage of a transverse string.

4. The modular furniture unit according to claim 3, wherein the transverse string configured to connect a furniture cover to a furniture body.

5. The modular furniture unit according to claim 3, wherein the string groove is embedded transversely and longitudinally within the bottom face of the link block and the bottom face of the top block.

6. The modular furniture unit according to claim 1, wherein the bottom face of the bottom block comprises at least one connection cap aperture.

7. The modular furniture unit according to claim 1, wherein the top face of the link block comprises at least one connection cap aperture embedded within a fastening protrusion tip.

8. The modular furniture unit according to claim 1, wherein the fastening protrusion and the fastening groove comprise a Lego-type fastening protrusion and a Lego-type fastening groove.

9. The modular furniture unit according to claims 1 and 8, wherein the fastening protrusion and fastening groove comprise a polygonal cross section geometry and an inner hollow space.

10. The modular furniture unit according to claim 9, wherein the polygonal cross section geometry comprises an octagonal cross-section.

11. The system according to claims 1 and 9, wherein the fastening groove is designed with a recess in the bottom face of the top block and the bottom face of the link block.

12. The system according to claim 11, wherein the recess has an octagonal cylindrical shape.

13. The system according to claim 12, wherein the octagonal cylindrical shape comprises a first section and a second section with a different inner diameter, wherein an inner diameter of the first section is larger than an inner diameter of the second section, wherein the fastening protrusion enters the fastening groove from the second section.

14. The modular furniture unit according to claim 9, wherein the inner hollow space configured to pass a support strap.

15. The modular furniture unit according to claims 6 and 7, wherein a connection cap configured to fasten the support strap and the connection cap is mounted on the connection cap aperture.

16. A multifunctional modular furniture system to produce various type of a furniture, comprising:
(i) a plurality of modular units configured to build a furniture structure, the modular units comprising:
a top block unit configured to build a furniture top outer surface;
a link block unit configured to build a furniture main body; and
a bottom block unit configured to build a furniture bottom surface on a ground;
(ii) a plurality of support units configured to reinforce the furniture structure against a pressure on the furniture structure, the support unit comprising:
a support strap configured to protect the furniture against a horizontal force on the furniture structure;
a connection cap configured to fasten the support strap.

17. The system according to claim 16, wherein the modular units is made of a polystyrene material.

18. The system according to claim 16, wherein the modular units is made of an expanded polystyrene.

19. The system according to claim 16, wherein the modular units have a polyhedron geometry.

20. The system according to claim 16, wherein the top block unit comprises at least four flat side walls, a flat top surface, and a top block connection side, wherein the top block connection side is embedded in a bottom surface of the top block unit, and the top block connection side comprises at least one Lego-type fastening groove.

21. The system according to claim 16, wherein the link block unit comprises at least four flat side walls, a first link block connection side, and a second link block connection side, wherein the first link block connection side is embedded in a top surface of the link block unit and the second link block connection side is embedded in a bottom surface of the link block unit, wherein the first link block connection side comprises at least one Lego-type fastening protrusion and the second link block connection side comprises at least one Lego-type fastening groove.

22. The system according to claim 16, wherein the bottom block unit comprises at least four flat side walls, a bottom block connection side, and a bottom surface, wherein the bottom connection side comprises at least one Lego-type fastening protrusion and the bottom surface comprises at least one connection cap cylindrical aperture and at least one flat cap cylindrical aperture.

23. The system according to claims 20, 21, and 22, wherein the Lego-type fastening protrusion and the Lego-type fastening groove comprise a polygonal cross section geometry and an inner hollow space, wherein the inner hollow space configured to pass the support strap.

24. The system according to claims 21 and 22, wherein the Lego-type fastening protrusion extending from a modular unit's surface, wherein the Lego-type fastening protrusion comprises an octagonal cross-section.

25. The system according to claim 21, wherein a top face of the link block comprises the connection cap cylindrical aperture embedded in a Lego-type fastening protrusion tip.

26. The system according to claims 20 and 21, wherein the Lego-type fastening groove comprises the octagonal cross-section and the Lego-type fastening groove is designed with a recess in the modular unit's surface.

27. The system according to claim 26, wherein the recess in the modular unit's surface comprises an octagonal cylindrical shape.

28. The system according to claim 27, wherein the octagonal cylindrical shape comprises a first section and a second section with a different inner diameter, wherein an inner diameter of the first section is larger than an inner diameter of the second section, wherein the fastening protrusion enters the fastening groove from the second section.

29. A multifunctional modular furniture system to produce various type of a furniture, comprising:
(i) a plurality of modular furniture units configured to build a furniture structure, the modular furniture units comprising:
a top block unit configured to build a furniture top outer surface, the top block unit comprising at least one fastening groove;
a link block unit configured to build a furniture main body, the link block unit comprising at least one fastening groove and at least one fastening protrusion; and
a bottom block unit configured to build a furniture bottom surface on a ground, the bottom block unit comprising at least one fastening protrusion, wherein:
the fastening groove comprises at least two sections with an octagonal cylindrical shape with a different inner diameter, wherein an inner diameter of a first section is larger than an inner diameter of a second section, wherein the first section is mounted on a top of the second section and the fastening protrusion enters the fastening groove from a bottom of the second section;
(ii) a plurality of support units configured to reinforce the furniture structure against a pressure on the furniture structure, the support unit comprising:
a support strap configured to protect the furniture against a horizontal force on the furniture structure; and
a connection cap configured to fasten the support strap.
